(19) United States
(12) Patent Application Publication
(10) Pub. No.: US 2014/0244545 A1
(43) Pub. Date: Aug. 28, 2014

(54) SYSTEM, METHOD, AND RECORDING MEDIUM

(71) Applicant: FUJITSU LIMITED, Kawasaki-shi (JP)

(72) Inventor: Yoshiro TSUJI, Shizuoka (JP)

(73) Assignee: FUJITSU LIMITED, Kawasaki-shi (JP)

(21) Appl. No.: 14/183,174

(22) Filed: Feb. 18, 2014

(30) Foreign Application Priority Data
Feb. 28, 2013 (JP) 2013-038516

(51) Int. Cl. H04L 29/06; G06Q 50/00; G06Q 30/02

(52) U.S. Cl. CPC H04L 63/101; G06Q 30/0283; G06Q 50/00
USPC 705/400; 726/29

(57) ABSTRACT

A system includes circuitry configured to identify an accumulated amount of service that has been provided by a service, and determine whether to restrict access to a software resource provided by the service based on the accumulated amount of service.

### CROSS-REFERENCE TO RELATED APPLICATION

This application is based upon and claims the benefit of priority from the prior Japanese Patent Application No. 2013-038516 filed on Feb. 28, 2013, the entire contents of which are incorporated herein by reference.

### FIELD

The embodiments discussed herein are related to a system, a method, and a recording medium.

### BACKGROUND

In recent years, there have been widespread services that provide users with software that they want to use through a network. For example, in a cloud computing service, a service called a “platform as a service” (PaaS) is provided.

PaaS is a service which provides a base function (platform), such as middleware, and the like, on which a user executes software that the user want to develop. In a service that provides software through a network, normally, a time period in which the user is allowed to use the software free of charge is set. And if that time period expires, the charges are paid on the basis of measured rates, and so on.

As a related-art service like this, for example, a proposal has been made of a technique in which an upper limit of the amount of use of software for each specific time period is set in advance, and if the amount of use exceeds the upper limit, generation and distribution of an enabling signal that allows use of the software are stopped. Also, a proposal has been made of a technique in which contents of an information service allowed to a customer are determined by a use qualification of the customer, and an information service of the determined contents is provided to the customer.

Related-art techniques have been disclosed in Japanese Laid-open Patent Publication Nos. 2002-055726 and 2008-102909.

### SUMMARY

According to an aspect of the invention, a system includes circuitry configured to identify an accumulated amount of service that has been provided by a service, and determine whether to restrict access to a software resource provided by the service based on the accumulated amount of service.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a server apparatus;

FIG. 2 is a diagram illustrating an example of a configuration of a server client system;

FIG. 3 is a diagram for explaining deployment of a server application;

FIG. 4 is a diagram for explaining formal contract request processing;

FIG. 5 is a diagram illustrating information stored in a user information storage table;

FIG. 6 is a diagram illustrating information stored in a server log storage unit;

FIG. 7 is a diagram illustrating information stored in a cache memory;

FIG. 8 is a diagram illustrating information stored in a definition information storage unit;

FIG. 9 is a flowchart illustrating operation of verification processing based on accumulated use time;

FIG. 10 is a flowchart illustrating operation of verification processing based on accumulated use time;

FIG. 11 is a flowchart illustrating operation of verification processing based on the number of connected user IP addresses and the number of authenticated users;

FIG. 12 is a diagram illustrating an example of operating results;

FIG. 13 is a diagram illustrating an example of server log information;

FIG. 14 is a diagram illustrating an example of information stored in a cache memory; and

FIG. 15 is a diagram illustrating an example of a hardware configuration of a computer used for the present embodiment.

### DESCRIPTION OF EMBODIMENTS

By the study of the inventors, in the case where a period that allows a user to use software free of charge is fixedly set, and a certain period from date and time at which the user started to use the software is set as a charge-free use period, if the charge-free use period expires from an initial start point in time, providing a charge-free use service is terminated, and thus the user often fails to fully use the software during the charge-free period.

In this manner, regardless of how long the user has actually used the software, a determination is made that the charge-free use period has passed from the initial start time, and use of the software is simply restricted. Accordingly, the user is not provided with a flexible charge-free use service based on substantial use of the software, and thus the service is hardly said to be satisfactory to the user.

By embodiments described later, it becomes possible to control a service level in accordance with the amount of actual use of a service.

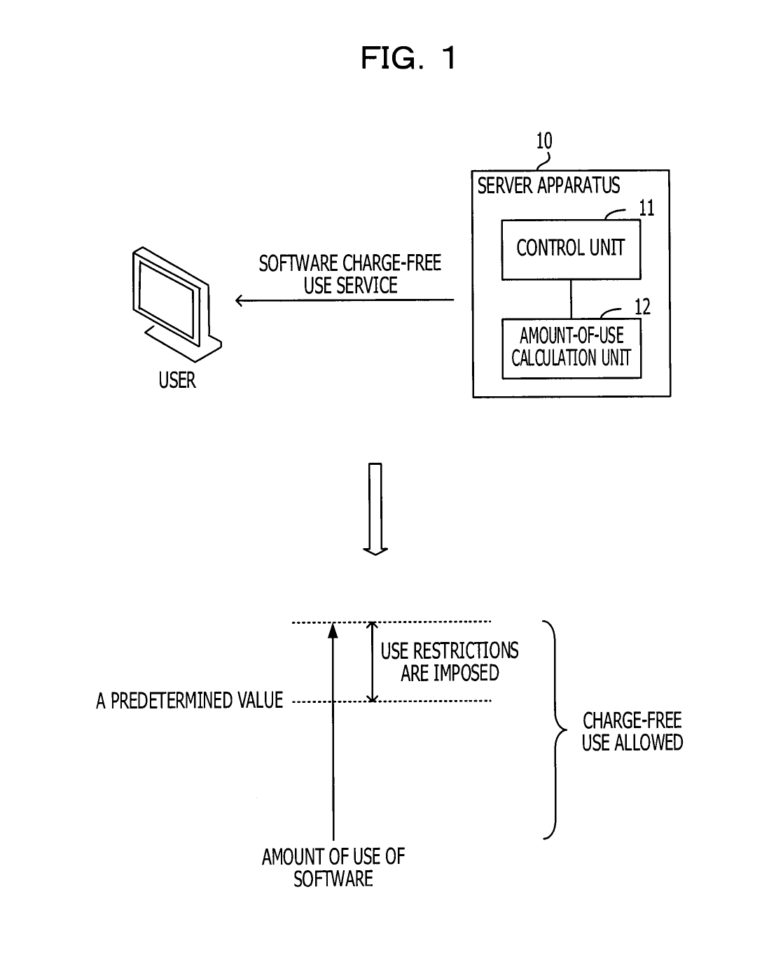

In the following, descriptions will be given of the embodiments with reference to the drawings. FIG. 1 is a diagram illustrating an example of a configuration of a server apparatus. The server apparatus 10 is an apparatus that provides a cloud computing service, and manages charge-free use of software. The server apparatus 10 includes a control unit 11 and an amount-of-use calculation unit 12.

The amount-of-use calculation unit 12 calculates the amount of use of the service by the user on a first use condition. The control unit 11 imposes restrictions on the service on the first use condition on the basis of a relationship between the amount of use and a setting value. In this regard, in the following, a description will be given of a software providing service as a specific example of the service.

Here, for example, the amount-of-use calculation unit 12 calculates, stores, and manages the amount of use of the software by the user free of charge. The control unit 11 has a function of a cloud operating system. The control unit 11 compares the calculated amount of use and the setting value. And if the amount of use exceeds the setting value, the control unit 11 imposes use restrictions on the charge-free use.

In this manner, by imposing use restrictions when the amount of use of the software by the user exceeds the setting value, it becomes possible to provide a charge-free use service of software in accordance with the amount of use, and thus it becomes possible to improve serviceability.

In the following, a detailed description will be given of operation. The server apparatus 10 provides a charge-free use service of software that provides a base function for executing software developed by the user on the cloud computing service.

Hereinafter, software developed by the user is called a user application, and software that provides a base function for executing the user application is called a server application.

Here, as a development environment in which software is executed on the cloud operating system, a test environment and an operation environment are mainly provided. For example, in Deployment (a development environment) of Windows Azure (a registered trademark), which is one of cloud operating systems, there are hosted service deployment areas which are called Staging and Production, respectively. Staging corresponds to the test environment, and Production corresponds to the operation environment.

In the test environment, a software test, and so on are carried out. After the software test in the test environment is complete, migration from the test environment to the operation environment is performed, and actual operation is performed. Accordingly, a test operation period of software in the test environment is set to be a charge free period, and an actual operation period of software in the operation environment is set to be a charged period of the software.

To date, a charge free period has been fixedly set. However, in the present technique, the charge free period is not fixedly set. And the charge free period is set on the basis of an accumulated use time period in which a user application has actually been performed in the test environment.

In this case, in calculation of the accumulated use time, a virtual machine (VM) size and multiplicity are added as factors. Further, the number of connected users and the number of authenticated users are recorded, and a determination is made of whether to prompt a request to change from the test environment in the charge free period to the operation environment in the charged period on the basis of the recorded values.

In this regard, the VM is a computer resource that is achieved by virtualizing resources, such as a central processing unit (CPU), a memory, and so on in the server. Also, the VM size is a performance index value of the VM corresponding to, for example, a CPU performance (a CPU clock frequency, and so on), and a memory capacity.

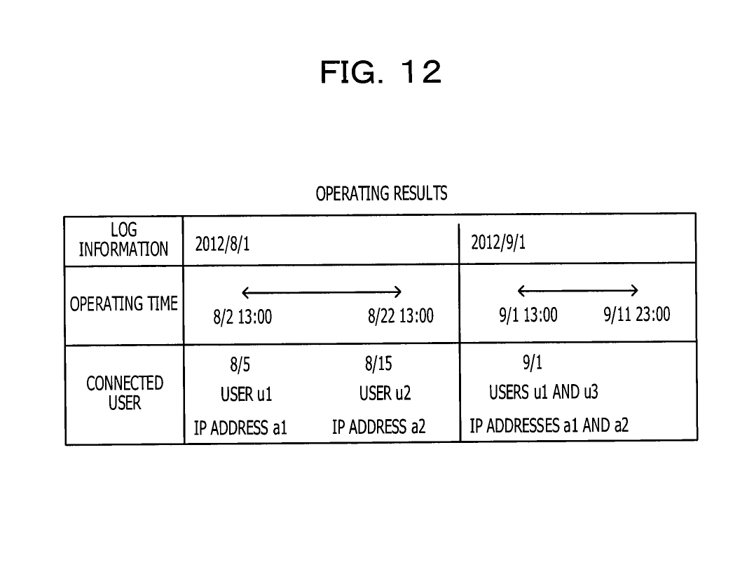

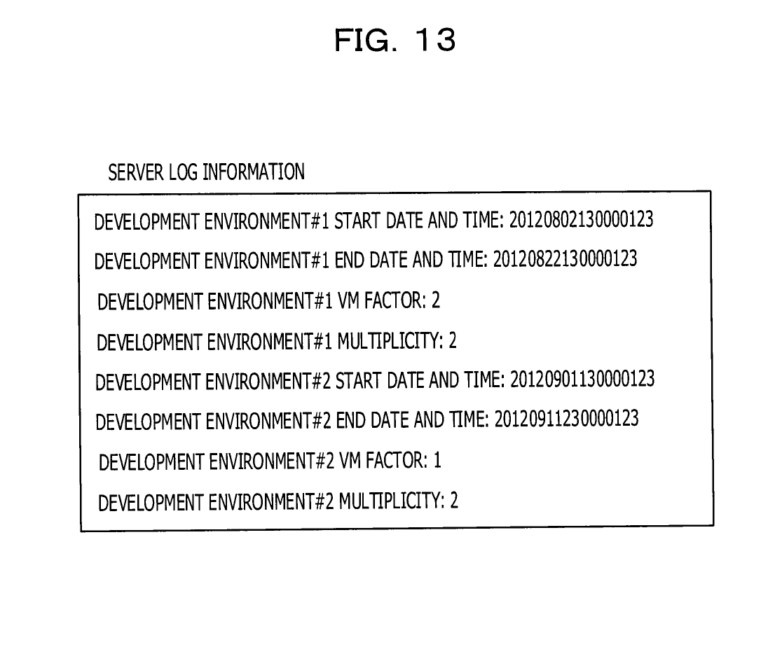

By virtualization of computer resources, it is possible for a plurality of VMs having different specifications to run on a single server at the same time (for example, it is possible to mixedly operate a high-specification VM and a low-specification VM), and thus it becomes possible to use the server effectively. In this regard, a description will be given later of a specific example of calculation of accumulated use time with reference to FIG. 12 and FIG. 13.

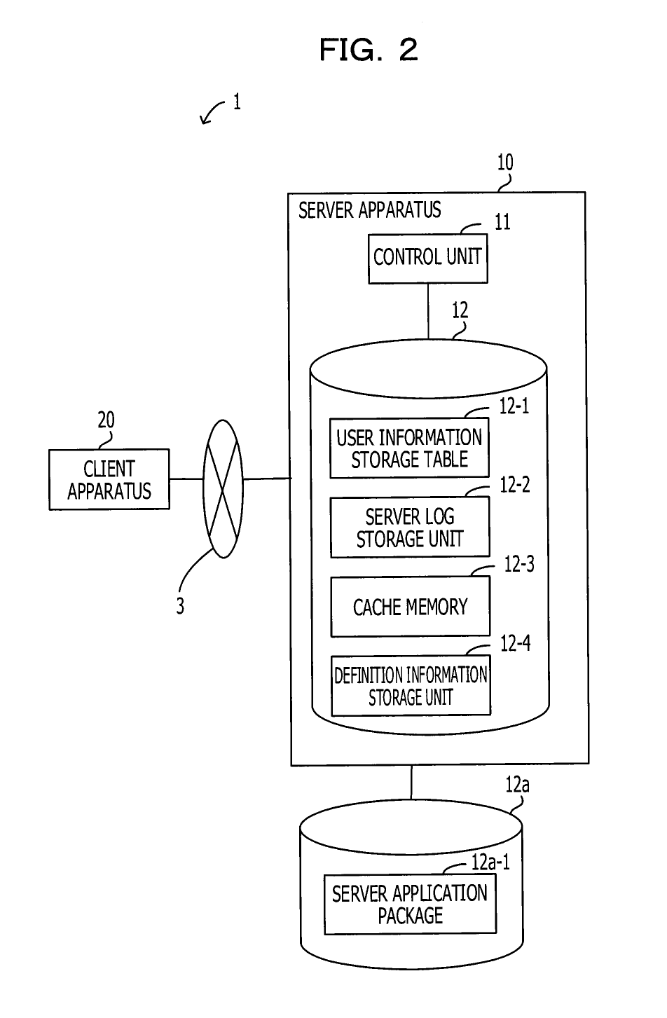

Next, a description will be given of a configuration of a server client system including the server apparatus 10. FIG. 2 is a diagram illustrating an example of a configuration of a server client system. A server client system 1 includes the server apparatus 10 and a client apparatus 20, which are connected to each other through a network 3.

The server apparatus 10 provides a server application that provides a base function for executing a user application on a cloud computing service to a client apparatus 20. The client apparatus 20 is a terminal used by a user.

The server apparatus 10 includes the above-described control unit 11 and the amount-of-use calculation unit 12, and is connected to a package repository 12a. The amount-of-use calculation unit 12 includes a user information storage table 12-1, a server log storage unit 12-2, a cache memory 12-3, and a definition information storage unit 12-4. The package repository 12a includes a server application package 12a-1.

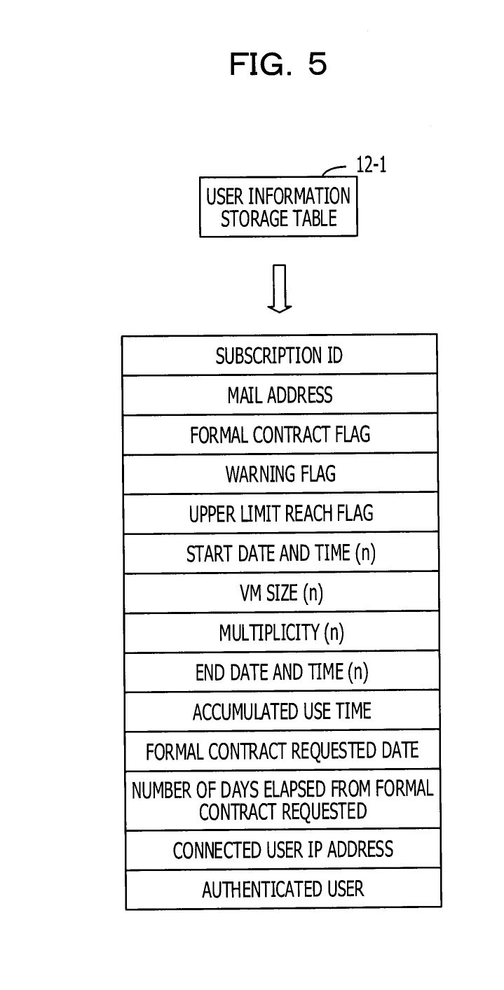

The package repository 12a is illustrated as having a configuration of being connected to the server apparatus 10 from the outside. However, the package repository 12a may have a configuration of being included in the server apparatus 10. In this regard, descriptions will be given of the user information storage table 12-1, the server log storage unit 12-2, the cache memory 12-3 and the definition information storage unit 12-4 with reference to FIG. 5 to FIG. 8, respectively.

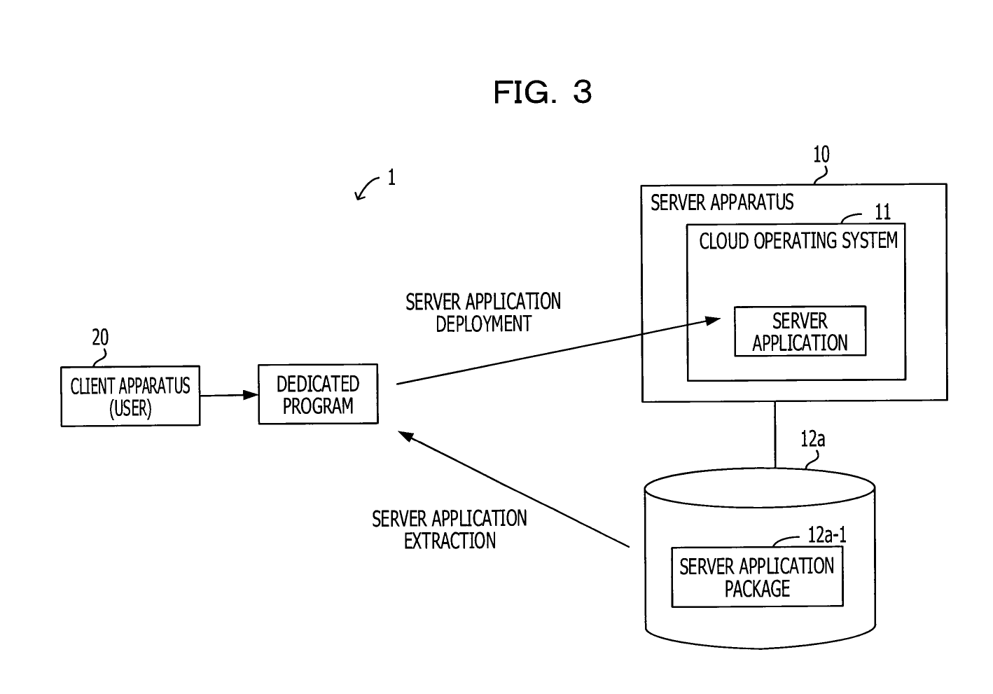

Next, a description will be given of a flow of deployment of a server application. FIG. 3 is a diagram for explaining deployment of a server application. Before starting a software charge-free use service, the server application is not deployed in the server apparatus 10. Accordingly, in order for the user to enjoy a software charge-free use service, first, the server application is deployed in the cloud operating system on the server apparatus 10.

It is possible to deploy the server application, for example using a dedicated program free of charge. Also, the server application package 12a-1 is stored in the package repository 12a attached to the server apparatus 10.

Accordingly, the user picks up the server application package 12a-1 from the package repository 12a using the dedicated program, and uploads the picked up server application package 12a-1 to the server apparatus 10. In this manner, it is possible to deploy a server application in the cloud operating system of the server apparatus 10.

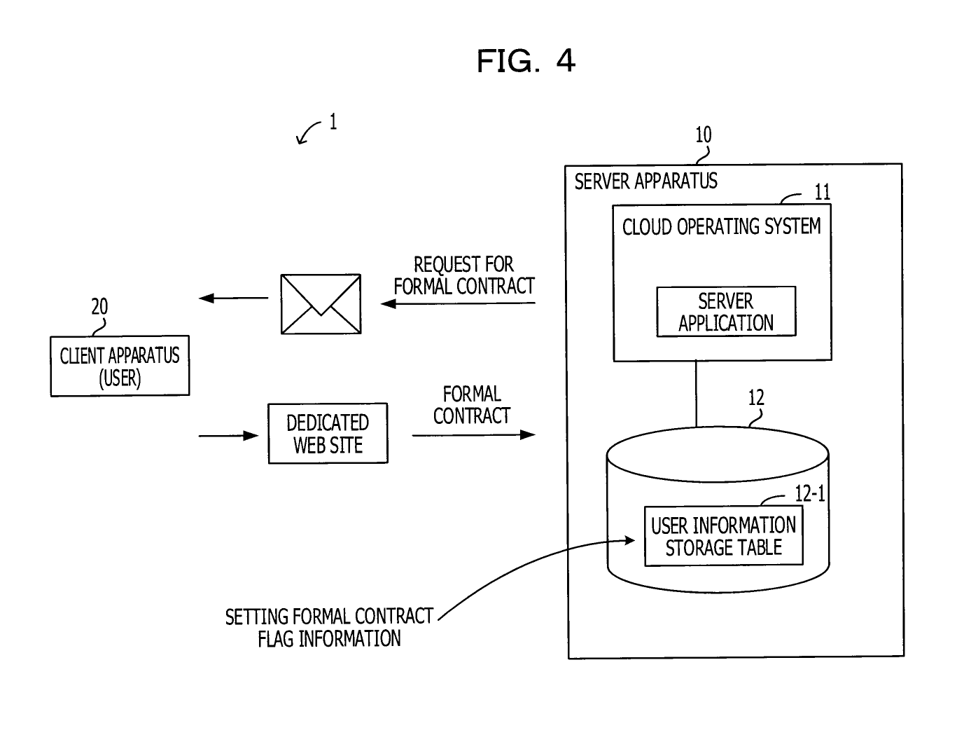

Next, a description will be given of a flow of formal contract request processing. FIG. 4 is a diagram for explaining formal contract request processing. In general, after completion of the software test in the test environment, the software is migrated from the test environment to the operation environment, and operation of software is performed. Accordingly, if the development environment in which the user application is executed is migrated from the test environment to the operation environment, the server apparatus 10 determines that the operation of the user application has started at that point in time even within the charge-free period.

The server apparatus 10 (control unit 11) automatically issues a notification mail that prompts the user to make a formal contract, and so on when the server apparatus 10 recognizes that operation of the user application has been started. When the user who received the mail has made the formal contract in a specific period through the dedicated Web site, information on the formal contract (flag information) is recorded in the user information storage table 12-1.

In this case, an electronic payment is made on the dedicated Web site, and after completion of the payment, the flag information indicating existence of a formal contract is written into a formal contract flag in the field of the user information storage table 12-1.

In this regard, although the operation has been started, if a formal contract is not made in a specific period, the server apparatus 10 does not allow operation in the operation environment, and allows only stopping this service, or test operation in the test environment during the charge free period.

Further, in the case where a user application is not replaced for a certain period of time in the test environment, the server apparatus 10 regards that production operation has been started, and thus the server apparatus 10 prompts the user to make a formal contract. In this case, if the formal contract is not made in a specific time period, operation in the operation environment is not allowed, and only stopping the service or test operation under the test environment in the charge free period is allowed.

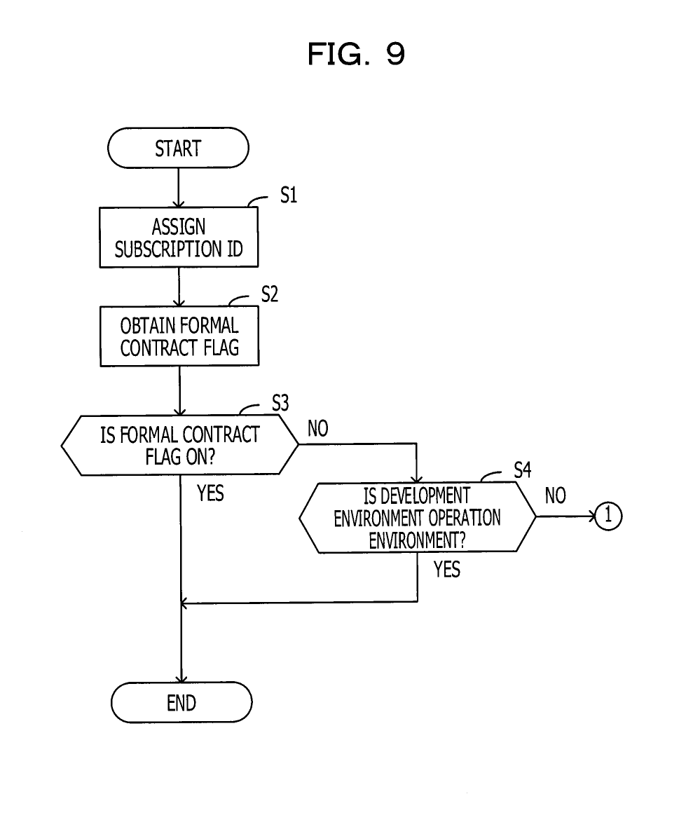

Further, in the case where the amount of use of the user application exceeds a certain rate of a setting value in the test environment, or the number of connected users or the number of authenticated users exceeds a permissible value, the server apparatus 10 performs the formal contract request processing as described above, which will be described later with reference to FIG. 9 and after that.

Next, a description will be given of the user information storage table 12-1. FIG. 5 is a diagram illustrating information stored in the user information storage table. The user information storage table 12-1 stores various kinds of user information for each user who is enjoying a charge-free use service provided by the server apparatus 10.

The user information to be stored includes, for example, a subscription (use contract) ID, a mail address, a formal contract flag, a warning flag, an upper limit reach flag, start date and time (n), a VM size (n), a multiplicity (n), end date and time (n), accumulated use time, formal contract request date, the number of days elapsed from formal contract requested, a connected user IP address, and an authenticated user.

The subscription ID is an ID to be assigned in order for the cloud operating system of the server apparatus 10 to identify a user who took out a subscription.

The mail address is an email address of the user. The formal contract flag is flag information indicating whether or not a formal contract has been made. If a flag state is on, a formal contract has been made, and if the flag state is off, a formal contract has not been made.

The warning flag is flag information indicating whether the accumulated use time has exceeded a certain rate (for example, 80% of an upper limit value) of a specific upper limit value or not. If the accumulated use time has exceeded the certain rate of the upper limit value, a warning has to be turned on, and thus the flag state becomes on. Otherwise the flag state is off.

The upper limit reach flag is flag information indicating whether or not at least one of the accumulated use time, the number of connected user IP addresses, and the number of authenticated users has reached an upper limit value. If at least one of them has reached the upper limit value, the flag state becomes on. If not reached the upper limit value, the flag state is off.

The start date and time (n) is date and time when a user application has been started to be used since a server application was deployed in the cloud operating system. The VM size (n) is a size (performance index) of a VM started at the time of deploying the server application in the cloud operating system.

Here, it is assumed that there are a plurality of VM sizes, for example, four VM sizes. At this time, it is assumed that VM size=4 represents a VM having a highest performance among the four VMs, and VM size=3 represents a VM having a second highest performance. Also, it is assumed that VM size=2 represents a VM having a third highest performance among the four VMs, and VM size=1 represents a VM having a lowest performance among the four VMs. By selecting one from the plurality of VM sizes like this, it becomes possible to separately use the VMs having different performances.

The multiplicity (n) indicates the number of started VMs at the time when the server application has been deployed in the cloud operating system. It is possible to start a plurality of the VMs at the same time, and thus the number of started VMs becomes the multiplicity. The end date and time (n) is date and time when use of a user application was stopped.

Here, the above-described parameter n indicates an identifier of a development environment, and the same number in the start date and time, the VM size, the multiplicity, and the end date and time indicates that these pieces of information belongs to the same development environment.

For example, it is assumed that use of a user application was started on a server application that was deployed at 10:00 on January 7th, the VM size factor=2 and the multiplicity=3 are selected for the VM at this time, and use of the user application ended at 17:00 on January 9th.

If the identifier n of the development environment at this time is 1, the above-described information is expressed as follows. The start date and time (1)=10:00 on January 7th, the VM size (1)=2, the multiplicity (1)=3, and the end date and time (1)=January 7th. In this manner, information having the same parameter value indicates the same development environment, and thus it is possible to clearly identify use history.

The accumulated use time is an accumulated time periods during which the user application has been used on the server application after the server application was deployed in the cloud operating system. The formal contract request date is date at which an email of a formal contract request was sent to the user.

The number of days elapsed from formal contract requested is the number of days that have passed from the formal contract request mail was sent. The connected user IP address is an IP address of the user who accessed the cloud operating system of the server apparatus 10, and the IP addresses are stored up to a maximum permissible number. The authenticated user is an ID of the user who has accessed the cloud operating system of the server apparatus 10, and the user IDs are stored up to a maximum permissible number.

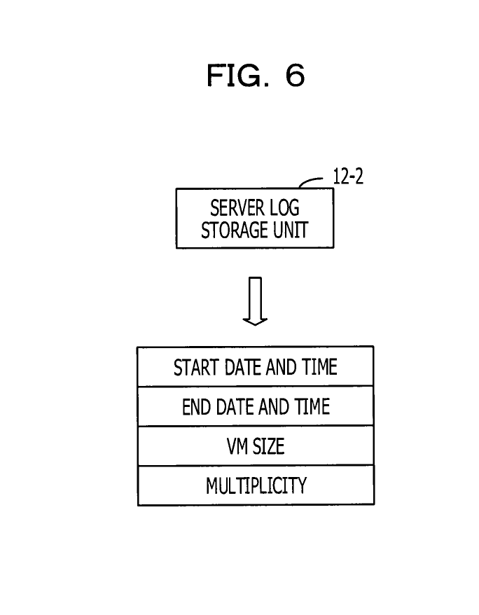

Next, a description will be given of the server log storage unit 12-2. FIG. 6 is a diagram illustrating information stored in the server log storage unit. The server log storage unit 12-2 stores server log (history) information that is created each time the user uses the cloud operating system.

The server log information is information desired at the time of starting use or at the time of ending. For example, the server log information includes start date and time, end date and time, a VM size, and a multiplicity. The contents of each information has been described above, and thus a description thereof will be omitted. In this regard, the server log information is reflected on the user information storage table 12-1 when the use is ended.

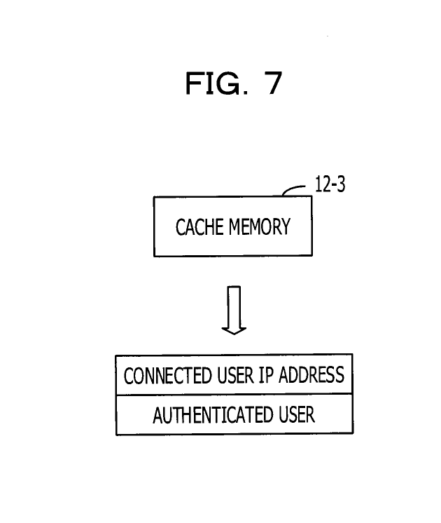

Next, a description will be given of the cache memory 12-3. FIG. 7 is a diagram illustrating information stored in the cache memory. The information stored in the cache memory 12-3 is information that is updated each time access occurs to the cloud operating system of the server apparatus 10. For example, the information includes a connected user IP address, and information on an authenticated user. These pieces of information is reflected on the user information storage table 12-1 at the time of update. The contents of each information has been described above, and thus a description thereof will be omitted.

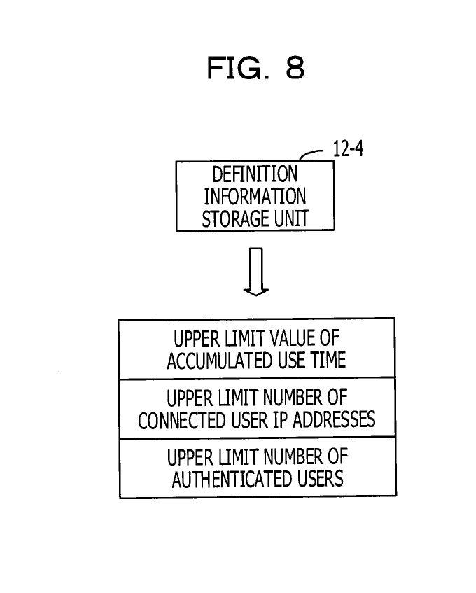

Next, a description will be given of the definition information storage unit 12-4. FIG. 8 is a diagram illustrating information stored in the definition information storage unit. The definition information storage unit 12-4 stores definition information to be defined in advance. For the definition information, for example, an accumulated use time upper limit value, an upper limit value of the number of connected-user IP addresses, and an upper limit value of the number of authenticated users are stored.

The upper limit value of accumulated use time is an upper limit definition value of a maximum available accumulated use time. The upper limit number of connected user IP addresses is an upper limit definition value of the maximum available number of connected user IP addresses. The upper limit number of authenticated users is an upper limit definition value of the maximum available number of authenticated users.

Next, a description will be given of verification processing based on the accumulated use time, the number of connected user IP addresses, or the number of authenticated users. In the test environment, and when the formal contract flag is off, verification processing is performed in order to verify whether or not use restriction is to be imposed on the charge-free use service of the software.

Verification processing based on accumulated use time

After the server application is deployed, the server apparatus 10 writes the start date and time at which the user application was started, the VM size, and the VM multiplicity to be used, and the end date and time at which the user application was stopped into the user information storage table 12-1. The server apparatus 10 calculates an accumulated use time from these, and writes a calculation result into the field of the accumulated use time in the user information storage table 12-1.

If the accumulated use time exceeds a certain rate of the upper limit value of accumulated use time, the server apparatus 10 reduces the usable VM size, and transmits a formal contract request mail. Also, if the accumulated use time exceeds the upper limit value of accumulated use time, or if formal contract is not made after the transmission of the formal contract request mail, the server apparatus 10 stops the charge-free use service of the server application.

In this manner, if the accumulated use time exceeds a certain rate of the upper limit value of accumulated use time, the server apparatus 10 reduces the usable VM size to impose use restrictions. Thereby, it is possible to provide a service in accordance with the amount of test use by the user, and to impose restrictions on use at suitable timing.

Also, unlike a related-art practice of simply stopping a service if a fixed charge free period has passed, use restrictions are imposed in accordance with the amount of test use. Accordingly, it becomes possible for the user to fully perform the test use, and thus it becomes possible to give a highly satisfactory service to the user.

Verification processing based on the number of connected user IP addresses

When a user connects to the cloud operating system, the server apparatus 10 stores an IP address of a user having an address (a referer has been appended) into the cache memory 12-3. And the server apparatus 10 adds the IP address stored in the cache memory 12-3 to the user information storage table 12-1 (the same address is not added).

If the maximum permissible number exceeds the number of connected user IP addresses in the user information storage table 12-1, the server apparatus 10 transmits a formal contract request mail to a user having the IP address with which accesses have been gained over the maximum permissible number. If a formal contract has not been made in a specific time period after transmission of the formal contract request mail, the server apparatus 10 stops the charge-free use service of the server application.

Verification processing based on the number authenticated users

The server apparatus 10 stores the user ID of the address (a referer has been appended) into the cache memory 12-3 at the time of authentication of the user who connected to the cloud operating system, and adds the user ID stored in the cache memory 12-3 to the user information storage table 12-1 (the same user ID is not added).

If the number of authenticated users in the user information storage table 12-1 exceeds the maximum permissible number, the server apparatus 10 transmits a formal contract request mail to a user having a user ID by which accesses have been gained over the maximum permissible number. After the transmission of the formal contract request mail, if a formal contract has not been made in a specific time period, the server apparatus 10 stops the charge-free use service of the server application.

Here, the cloud operating system recognizes the difference between the test environment and the operation environment by a uniform resource locator (URL). Thus, the user might carry out operation in the test environment after development of a user application. Accordingly, as described above, an address to which a referer has been appended is obtained, and is used for verification processing. Also, if the user migrates from the operation environment to the test environment after a formal contract, the formal contract is canceled once, and the operation is returned to the test environment to enable the test use.

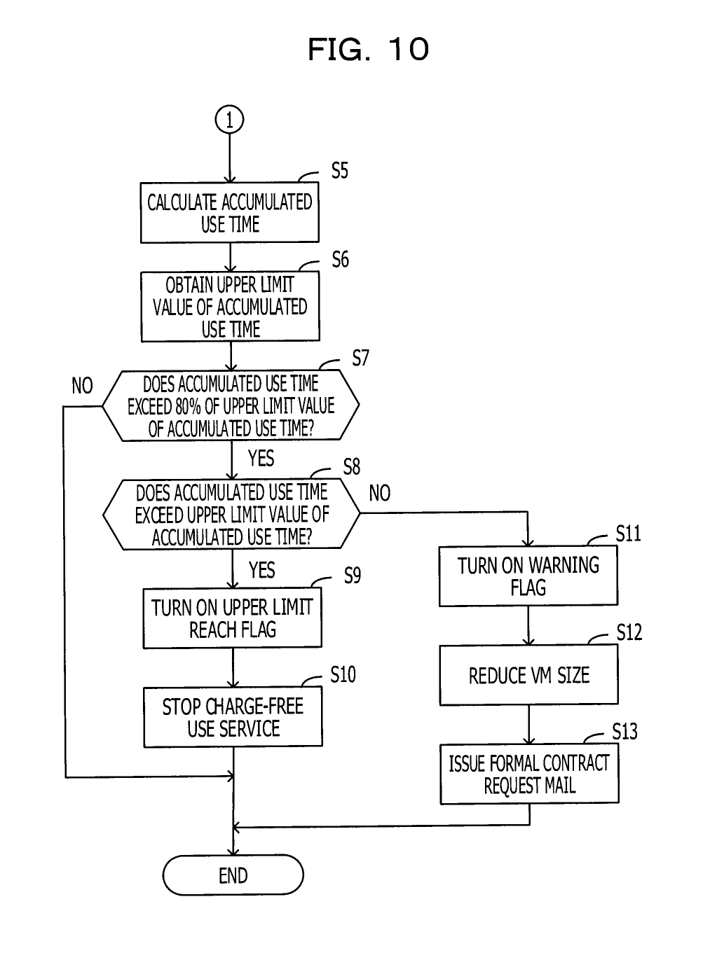

Next, a description will be given using flowcharts. FIG. 9 and FIG. 10 are flowcharts illustrating operation of verification processing based on accumulated use time.

S1: The control unit 11 assigns a subscription ID to a user.

S2: The control unit 11 obtains a formal contract flag from the user information storage table 12-1 using the subscription ID as a key.

S3: The control unit 11 determines the flag state of the formal contract flag. If the flag state is on, it means that a formal contract has been made, and thus the verification processing is terminated. If the flag state is off, a formal contract has not been made yet, and thus the processing proceeds to step S4.

S4: The control unit 11 determines whether the current development environment type is the operation environment or not. If it is the operation environment, the processing is terminated, and if it is not the operation environment (if the test environment), the processing proceeds to step S5.

S5: When the control unit 11 recognizes that the current development environment is the test environment, and the formal contract flag is off, the control unit 11 calculates the accumulated use time.

S6: The control unit 11 obtains the upper limit value of the accumulated use time from the definition information storage unit 12-4.

S7: The control unit 11 determines whether or not the calculated accumulated use time exceeds, for example 80% of the upper limit value of the accumulated use time. If it exceeds, the processing proceeds to step S8. If it does not exceed, the verification processing is terminated, and the charge-free use service is continued.

S8: The control unit 11 determines whether or not the calculated accumulated use time exceeds the upper limit value of the accumulated use time. If it exceeds, the processing proceeds to step S9. If it does not exceed, the processing proceeds to step S11.

S9: The control unit 11 turns on the upper limit reach flag, and sets the flag in the user information storage table 12-1.

S10: The control unit 11 stops the charge-free use service.

S11: The control unit 11 turns on the warning flag, and sets the flag in the user information storage table 12-1.

S12: The control unit 11 reduces the VM size, and allows only use of a VM (a VM having a low performance index) having a VM size smaller than the VM size currently being used by the test operation.

S13: the control unit 11 issues a formal contract request mail.

In this manner, if the accumulated use time indicating the user's amount of use exceeds a certain rate of the upper limit value of the accumulated use time, the control unit 11 reduces the VM size to impose use restrictions. If the accumulated use time exceeds the upper limit value of the accumulated use time, the control unit 11 stops the charge-free use service. Thereby, it becomes possible to provide a flexible charge-free use service corresponding to the amount of use by the user.

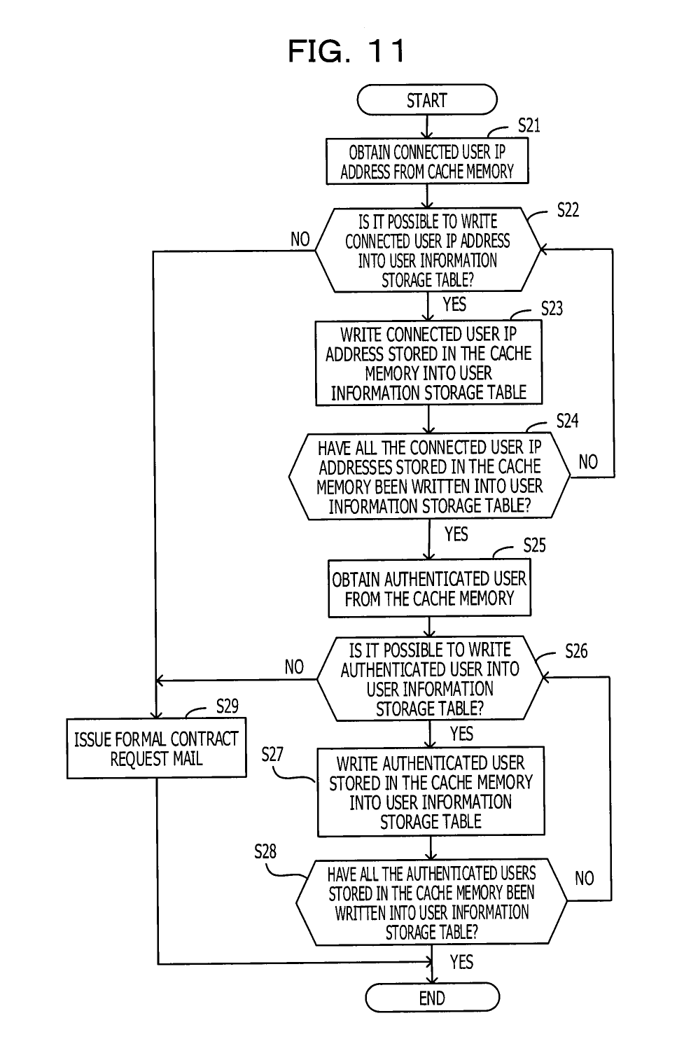

FIG. 11 is a flowchart illustrating operation of verification processing based on the number of connected user IP addresses and the number of authenticated users.

S21: The control unit 11 obtains a connected user IP address from the cache memory 12-3.

S22: The control unit 11 determines whether it is possible to write the connected user IP address obtained from the cache memory 12-3 into the field of the connected user IP address in the user information storage table 12-1. If it is possible to write, the processing proceeds to step S23. If the number has already reached the maximum permissible number, and thus it is not possible to write, the processing proceeds to step S29.

S23: The control unit 11 writes the connected user IP address obtained from the cache memory into the field of the connected user IP address in the user information storage table 12-1.

S24: The control unit 11 determines whether all the connected user IP addresses in the cache memory 12-3 have been written into the user information storage table 12-1. If not written, the processing returns to step S22. If written, the processing returns to step S25.

S25: The control unit 11 obtains an authenticated user from the cache memory 12-3.

S26: The control unit 11 determines whether it is possible to write the authenticated user obtained from the cache memory 12-3 into the field of the authenticated user in the user information storage table 12-1. If it is possible to write, the processing proceeds to step S27. If the number has already reached the maximum permissible number, and thus it is not possible to write, the processing proceeds to step S29.

S27: The control unit 11 writes the authenticated user obtained from the cache memory 12-3 into the field of the authenticated user in the user information storage table 12-1.

S28: The control unit 11 determines whether all the authenticated users in the cache memory 12-3 have been written into the user information storage table 12-1. If not written, the processing returns to step S26. If written, the processing is terminated.

S29: The control unit 11 transmits a formal contract request mail to a user having the IP address by which accesses are gained in excess of a maximum permissible number, or a user having the user ID by which accesses are gained in excess of the maximum permissible number.

In this manner, the verification processing based on the number of connected user IP addresses and the number of authenticated users is performed so that it becomes possible to suitably set the number of users that are allowed to the charge-free use.

Next, a description will be given by taking a specific example. FIG. 12 is a diagram illustrating an example of operating results. FIG. 12 illustrates the results of operation of the user application after the server application was deployed in the server apparatus 10.

The operating time slot of the user application in August 2012 indicates that 13:00 August 2nd is the start date and time, and 13:00 August 22nd is the end date and time. Also, the operating time slot of the user application in September 2012 indicates that 13:00 September 1st is the start date and time, and 23:00 September 11th is the end date and time.

Further, the connected users in August 2012 indicates that a user u1 of an IP address a1 connected on August 5th, and a user u2 of an IP address a2 connected on August 15th. Further, the connected users in September 2012 indicate that users u1 and u3 having IP addresses a1 and a2, respectively connected on September 1st. FIG. 13 is a diagram illustrating an example of server log information. FIG. 13 illustrates an example of start date and time, end date and time, a VM size, and a multiplicity for each development environment, which are stored in the server log storage unit 12-2.

Here, a definition is given to the accumulated use time of the user application from the start date and time to the end date and time in a single development environment by the following expression.

(Accumulated use time)=((end date and time)−(start date and time))×VM size×multiplicity

In this manner, the accumulated use time is obtained not only by the actual operating time, but by weighting the actual operating time with the VM size and the multiplicity so that it is possible to express the accumulated amount of use by a numeric value in accordance with the amount of used resources.

Accordingly, for example, it is possible to determine whether a user who uses this service is a heavy user using a high-specification VM or not. If the user is a heavy user, the speed of the accumulated use time that reaches the upper limit value becomes quick, and thus it becomes possible to make a formal contract request earlier accordingly.

Here, in the development environment #1, with reference to FIG. 12 and FIG. 13, the time period from the start date and time to the end date and time is 24 hours×20 days, the VM size=2, and the multiplicity=2, and thus the accumulated use time of the development environment #1 becomes as follows. (Accumulated use time of development environment #1)=(24×20)×2×2=1920.

Also, in the development environment #2, with reference to FIG. 12 and FIG. 13, the time period from the start date and time to the end date and time is 24 hours×20 days and 10 hours, the VM size=1, and the multiplicity=2, and thus the use time of the development environment #2 becomes as follows. (Accumulated use time of development environment #2)=(24×10+10)×1×2=500. Accordingly, the total value of the development environments #1 and #2 becomes 2420 hours (=1920+500), and this value is stored in the accumulated use time of the user information storage table 12-1.

In the calculation described above, the user application is not operated during the time period from 13:00 August 22nd to 13:00 September 1st, and thus this time period is not included in the accumulated use time (in a related-art method, this time period is also counted).

Also, the server apparatus 10 weights the actual operating time from the start date and time to the end date and time with the amount of used resources, such as the VM size, and the multiplicity to calculate the accumulated use time of the user application. And the server apparatus 10 compares the accumulated use time calculated as described above, and the upper limit value of accumulated use time. For example, the time period is set to 30 days, the VM size=the multiplicity=2, and the upper limit value of the accumulated use time is set to be 2880 hours (=30 days×2×2) and so on.

By a result of the comparison, if the calculated accumulated use time does not exceed the upper limit value of the accumulated use time, it is possible to continue the charge free period. However, even when the calculated accumulated use time does not exceed the upper limit value of the accumulated use time, if the accumulated use time exceeds a certain rate of the upper limit value of accumulated use time, for example, 80% of the upper limit value of the accumulated use time, the server apparatus 10 reduces the usable VM size, and issues a formal contract request mail.

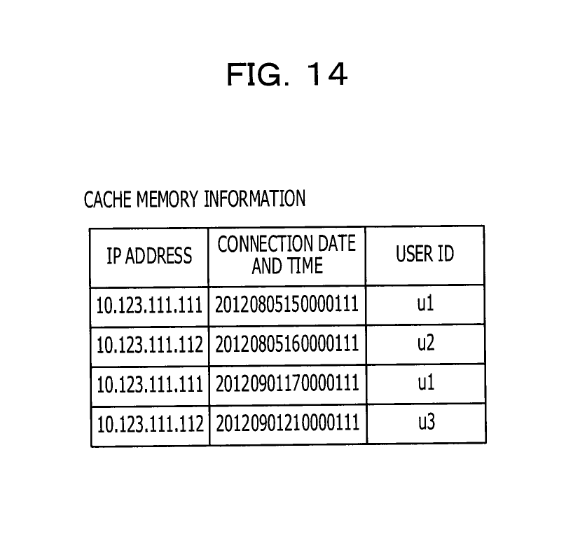

FIG. 14 is a diagram illustrating an example of information stored in the cache memory. FIG. 14 illustrates an example of an IP address, connected date and time, and a user ID, which are stored in the cache memory 12-2. The server apparatus 10 counts different IP addresses and user IDs, and stores the counts in the user information storage table 12-1. In this example, the number of different IP addresses=2, and the number of different authenticated users=3.

And if at least one of the number of IP addresses and the number of authenticated users that are stored in the cache memory 12-2 exceeds the upper limit value, the server apparatus 10 issues a formal contract request mail to a user having an IP address by which accesses are gained over the maximum permissible number, or a user having a user ID by which accesses are gained over the maximum permissible number.

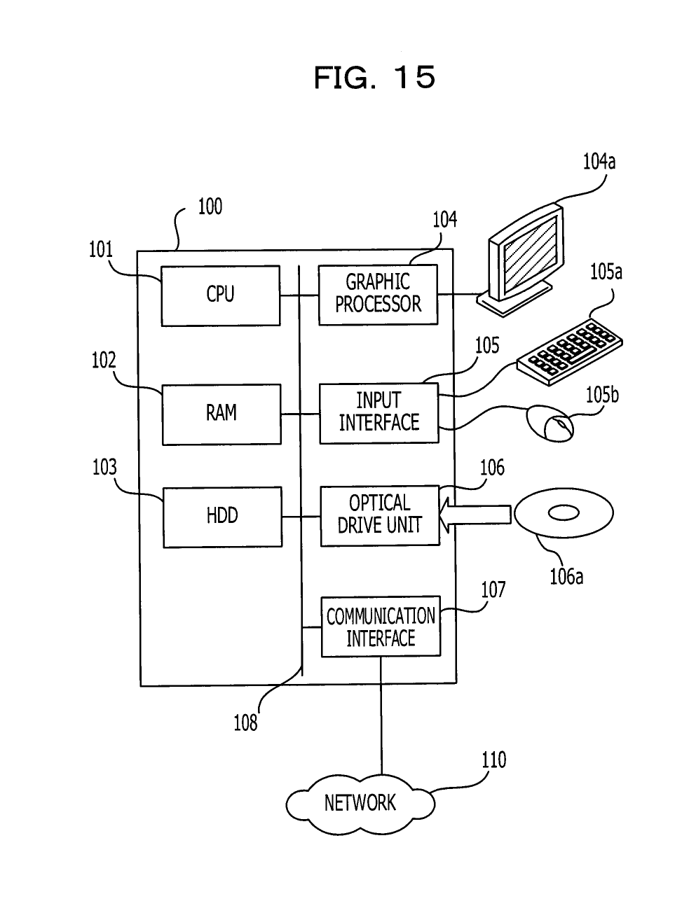

In this regard, it is possible to achieve the processing function described above by a computer. FIG. 15 is a diagram illustrating an example of a hardware configuration of a computer used for the present embodiment. A computer 100 in the server apparatus 10 is totally controlled by a CPU 101. A random access memory (RAM) 102 and a plurality of peripheral devices are connected to the CPU 101 through a bus 108.

The RAM 102 is used as a main storage unit of the computer 100. At least a part of an operating system (OS) program and an application program that are executed by the CPU 101 are temporarily stored in the RAM 102. Also, various kinds of data that are to be used for processing by the CPU 101 are stored in the RAM 102.

As peripheral devices connected to the bus 108, an hard disk drive (HDD) 103, a graphic processor 104, an input interface 105, an optical drive unit 106, and a communication interface 107 are provided.

The HDD 103 magnetically reads and writes data from and to an internal disk. The HDD 103 is used as a secondary storage unit of the computer 100. The HDD 103 stores the OS program, application programs, and various kinds of data. In this regard, as a secondary storage unit, it is also possible to use a semiconductor storage apparatus, such as a flash memory, and so on.

A monitor 104a is connected to the graphic processor 104. The graphic processor 104 displays an image on a screen of the monitor 104a in accordance with an instruction from the CPU 101. For the monitor 104a, a display unit using a cathode ray tube (CRT), and a liquid crystal display apparatus, and so on are provided.

A keyboard 105a and a mouse 105b are connected to the input interface 105. The input interface 105 transmits a signal that is transmitted from the keyboard 105a and the mouse 105b to the CPU 101. In this regard, the mouse 105b is an example of a pointing device, and thus one of the other pointing devices may be used. The other pointing devices include a touch panel, a tablet, a touch pad, a track ball, and the like.

The optical drive unit 106 reads data recorded on an optical disc 106a using laser light, and so on. The optical disc 106a is a portable recording medium on which data is recorded so as to allow reading by light reflection. For the optical disc 106a, a digital versatile disc (DVD), a DVD-RAM, a compact disc read only memory (CD-ROM), a CD-R (Recordable)/RW (Rewritable), and so on are provided.

The communication interface 107 is connected to a network 110. The communication interface 107 transmits and receives data with the other computers or communication devices through the network 110.

With the above hardware configuration, it is possible to achieve the processing functions of the present embodiment. Also, when the processing functions of the present embodiment is achieved by a computer, a program describing the processing contents of the functions of the server apparatus 10 is provided.

By executing the program on a computer, the above-described processing function is achieved on the computer. It is possible to record the program that describes the processing contents in a recording medium readable by a computer. For the recording medium readable by a computer, a magnetic storage device, an optical disc, a magneto optical recording medium, a semiconductor memory, and so on are provided. For the magnetic storage device, a hard disk drive (HDD), a flexible disk (FD), a magnetic tape, and so on are provided. For the optical disc, a DVD, a DVD-RAM, a CD-ROM/RW, and so on are provided. For the magneto optical recording medium, a magneto optical disk (MO), and so on is provided. In this regard, a recording medium that records the program does not include temporary propagation signal itself.

When the program is distributed, for example, a portable recording medium, such as a DVD, a CD-ROM, and so on, on which the program is recorded, is marketed. Also, it is also possible to store the program in the storage unit of the server computer, and to transfer the program to the other computers from the server computer through the network.

The computer that executes the program stores, for example, the program recorded on the portable recording medium, or the program transferred from the server computer into the own storage device of the computer. And the computer reads the program from the own storage device, and executes the processing in accordance with the program. In this regard, it is also possible for the computer to directly read the program from the portable recording medium, and to execute processing in accordance with the program. Also, it is possible for the computer to execute processing in accordance with the program received in sequence each time the program is transferred from the server computer.

Also, it is possible to achieve at least a part of the processing functions described above by an electronic circuits, such as a digital signal processor (DSP), an application specific integrated circuit (ASIC), a programmable logic device (PLD), and the like.

As described above, by the present technique, a software charge-free use service is provided on the basis of the use results, such as a time period during which the software is substantially used, the VM size, the multiplicity, or the number of access users, and so on.

Thereby, it is possible for the user to effectively develop a user application, because a charge free period is consumed as much time as the server is used, and thus it becomes possible to improve serviceability of the software charge-free use service.

In this regard, in the above-described embodiment, a description has been given of the case where the present technique is applied to a service in which a server application, which is a base function for executing a user application to be developed by the user, is provided free of charge by taking PaaS of a cloud computing service as an example.

On the other hand, it is possible to apply the present technique to “software as a service” (SaaS) of a cloud computing service. That is to say, it is also possible to apply the present technique in the same manner to the case where a user selects individual applications to develop a software, and the user is provided with a charge-free use service.

In the above, an embodiment is exemplified. However, it is possible to replace the configuration of each unit illustrated in the embodiment by the other unit having the similar functions. Also, any other components and processes may be added.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system comprising:
circuitry configured to
identify an accumulated amount of service that has been provided by a service; and
determine whether to restrict access to a software resource provided by the service based on the accumulated amount of service.

2. The system of claim 1, wherein
the accumulated amount of service is determined based on an amount of time the service is provided.

3. The system of claim 1, wherein
the accumulated amount of service is determined based on a number of virtual machines accessed when the service is provided.

4. The system of claim 1, wherein
the accumulated amount of service is determined based on a performance parameter corresponding to one or more virtual machines accessed when the service is provided.

5. The system of claim 1, wherein
the software resource includes at least a first virtual machine providing service at a first level and access to at least a second virtual machine providing service at a second level, which is lower than the first level.

6. The system of claim 5, wherein
the circuitry is configured to provide access only to the at least a second virtual machine when it is determined to restrict access to the software resource.

7. The system of claim 1, wherein
the circuitry is configured to control outputting a notification to change to a second access condition of the software resource from a first access condition of the software resource when it is determined to restrict access to the software resource.

8. The system of claim 7, wherein
the notification is generated as an electronic message and is sent to a device accessing the service.

9. The system of claim 1, wherein
the accumulated amount of service corresponds to an amount of service that has been provided by the service free of charge.

10. The system of claim 1, wherein
the service provides access to first operating environment free of charge and provides access to a second operating environment as a pay-based service.

11. The system of claim 10, wherein
the accumulated amount of service corresponds to an amount of access to the first operating environment that has been provided by the service.

12. The system of claim 11, wherein
the circuitry determines to restrict access to the first environment when the accumulated amount of service exceeds a threshold.

13. The system of claim 12, wherein
the circuitry is configured to control transmitting a notification to switch to the second environment when the accumulated amount of service exceeds the threshold.

14. The system of claim 1, wherein the circuitry is configured to:
store an identifier if a device accessing the service; and
control transmitting a request prompting a contract of chargeable use of the software resource to the device when it is determined to restrict access to the software resource.

15. The system of claim 14, wherein
the identifier is an IP address of the device.

16. The system of claim 14, wherein
the identifier is a user ID corresponding to a user of the device.

17. The system of claim 1, wherein
the software resource includes a first software platform corresponding to a test area and a second software platform corresponding to an implementation area.

18. The system of claim 17, wherein the circuitry is configured to:
restrict access to the test area when the accumulated amount of service exceeds a threshold.

19. A method performed by an information processing system, the method comprising:
identifying, by circuitry of the system, an accumulated amount of service that has been provided by a service; and
determining, by the circuitry, whether to restrict access to a software resource provided by the service based on the accumulated amount of service that has been provided.

20. A non-transitory computer-readable medium including a program, which when executed by an information processing system, cause the system to:
identify an accumulated amount of service that has been provided by a service; and
determine whether to restrict access to a software resource provided by the service based on the accumulated amount of service that has been provided.
